(19) United States
(12) Patent Application Publication
(10) Pub. No.: US 2006/0229025 A1
(43) Pub. Date: Oct. 12, 2006

(54) Method for extracting optimal reverse link capacity by scaling reverse link Eb/No setpoint based on aggregate channel load and condition

(75) Inventors: Asif D. Gandhi, Iselin, NJ (US); Mathew Thomas, Madison, NJ (US)

Correspondence Address: MCCORMICK, PAULDING & HUBER LLP, 185 ASYLUM STREET, CITY PLACE II, HARTFORD, CT, 06103, US

(73) Assignee: Lucent Technologies Inc., Murray Hill, NJ (US)

(21) Appl. No.: 11/094,594

(22) Filed: Mar. 30, 2005

(51) Int. Cl. H04B 7/00; H04Q 7/20

(52) U.S. Cl. 455/69; 455/522; 455/13.4

(57) ABSTRACT

A method for extracting the optimal capacity in a cellular network reverse link involves controlling the reverse link Eb/No setpoint (or other control setting) based on the aggregate reverse link load and channel condition. The cellular network includes a plurality of mobile stations that wirelessly communicate with a base station over a reverse link, using a CDMA or similar communications protocol. The base station calculates a received signal strength indicator (“RSSI”). If the RSSI rises above a designated threshold level, the base station calculates a scaling factor. The base station then scales its reverse link Eb/No setpoint by applying the scaling factor to the Eb/No setpoint. Then, according to the new, scaled Eb/No setpoint, the base station issues closed loop power control commands to the mobile stations, thereby adjusting their transmit power according to the new, scaled Eb/No setpoint.

### FIELD OF THE INVENTION

The present invention relates to telecommunications and, more particularly, to wireless communications systems.

### BACKGROUND OF THE INVENTION

FIG. 1 illustrates the topography of a typical cellular telecommunications network 10 (e.g., mobile phone network). The network 10 is geographically divided into a number of cells or sectors 12, which are typically contiguous and which together define the coverage area of the network 10. Each cell 12 is served by a base station 14, which includes one or more fixed/stationary transceivers and antennae 16 for wireless communications with a set of distributed mobile stations 18 (e.g., mobile phones) that provide service to the network's users. The base stations 14 are in turn connected (either wirelessly or through land lines) to a mobile switching center (“MSC”) 20, which serves a particular number of base stations depending on network capacity and configuration. The mobile switching center 20 acts as the interface between the wireless/radio end of the network 10 and a public switched telephone network or other network(s) 22, including performing the signaling functions necessary to establish calls or other data transfer to and from the mobile stations 18.

Various methods exist for conducting wireless communications between the base stations 14 and mobile stations 18. One such method is the CDMA (code division multiple access) spread-spectrum multiplexing scheme, widely implemented in the United States under the “IS-95,” “IS-2000,” or other standards. In a CDMA-based network, transmissions from the mobile stations 18 to the base stations 14 are across a single frequency bandwidth known as the reverse link 24, e.g., 1.25 MHz centered at a first designated frequency. Generally, each mobile station 18 is allocated the entire bandwidth all of the time, with the signals from individual mobile stations being differentiated from one another using an encoding scheme. Transmissions from the base stations 14 to the mobile stations 18 are across a similar frequency bandwidth (e.g., 1.25 MHz centered at a second designated frequency) known as the forward link 26. The forward and reverse links may each comprise a number of traffic channels and signaling or control channels, the former primarily for carrying data, and the latter primarily for carrying the control, synchronization, and other signals required for implementing CDMA communications.

The reverse link 24 in a CDMA network is primarily characterized by three interrelated variables, quality, capacity, and power. Power relates to the power transmitted by the mobile stations 18, while capacity relates to the amount of information that can be transmitted across the reverse link 24, e.g., bits/sec or symbols/sec (which is in turn related to the number of active mobile stations 18 on the reverse link 24). Quality relates to the quality of the signals received at the base stations 14, which is typically defined in a CDMA network by the signal-to-noise ratio Eb/No and a resultant metric such as frame or packet error rate. Eb/No is the energy per bit to interference density ratio. Generally speaking, in a CDMA reverse link, for a set average output power level, as quality is increased, the capacity decreases. In a sense, this is because more resources are devoted to ensuring quality that could otherwise be used for additional capacity.

In CDMA or similar networks, the desired signal quality level (e.g., Eb/No) is set at the base stations 14. Although a high quality signal is always desirous, if the quality level is set arbitrarily high, the reverse link capacity will be unnecessarily limited. Therefore, since under certain conditions the CDMA reverse link 25 is a limiting factor in the network generally (in terms of overall network capacity), it may be beneficial to modify the signal quality level to optimize reverse link capacity. In particular, maximum capacity is typically achieved when the Eb/No of every mobile station is set at the minimum level needed for acceptable channel performance.

### SUMMARY OF THE INVENTION

According to an embodiment of the present invention, a method for extracting the optimal capacity in a cellular network reverse link involves adjusting one or more of the control settings associated with the reverse link control parameters that determine how the base and mobile stations communicate, based on the aggregate reverse link load and channel conditions. For example, the reverse link Eb/No setpoint is one of the possible control settings that can be adjusted or controlled.

The cellular network includes a plurality of mobile stations that wirelessly communicate with a base station over a reverse link, using a CDMA or similar communications protocol. In carrying out the method, the base station determines if the aggregate load on the reverse link has reached a predetermined level. This may be done by first calculating a received signal strength indicator (“RSSI”) as a measure of the aggregate load, and then determining if the RSSI has passed a designated threshold level. If so, or if it is otherwise determined that the reverse link has reached the predetermined level of loading, the base station calculates a scaling factor that takes into account various channel load and/or condition factors. The base station then scales its reverse link Eb/No setpoint by applying the scaling factor to the Eb/No setpoint. Then, according to the new, scaled Eb/No setpoint, the base station issues closed loop power control commands to the mobile stations, thereby adjusting their transmit power according to the new, scaled Eb/No setpoint. As should be appreciated, an increase in the RSSI above the threshold is an indication that a high enough level of power is being received at the base station (due to proximate mobile stations and/or high quality channel conditions) for a downwards adjustment in the Eb/No setpoint, which results in lower mobile station transmit power levels and increased capacity.

### BRIEF DESCRIPTION OF THE DRAWINGS

The present invention will be better understood from reading the following description of non-limiting embodiments, with reference to the attached drawings, wherein below:

FIG. 1 is a schematic diagram of a cellular telecommunications network according to the prior art;

FIG. 2 is a schematic diagram of a cellular network according to an embodiment of the present invention;

FIG. 3 is a flowchart showing the steps of a method for extracting optimal reverse link capacity;

FIG. 4 is a schematic diagram illustrating the setting of a scaling factor; and

FIGS. 5 and 6 are flowcharts showing the steps of various methods for controlling a minimum Eb/No setpoint.

### DETAILED DESCRIPTION

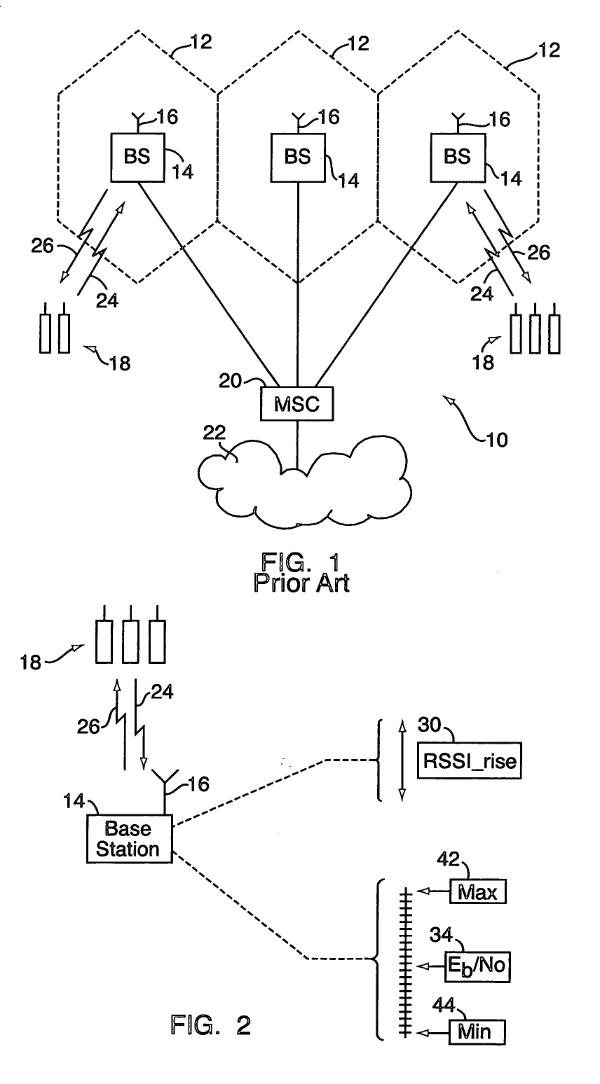

Referring to FIGS. 2-6, an embodiment of the present invention relates to a method for extracting the optimal capacity in a cellular network reverse link, by controlling the reverse link Eb/No setpoint based on the aggregate reverse link load and channel conditions. The cellular network includes one or more base stations 14 that wirelessly communicate with a number of mobile stations 18 over a reverse link 24 (i.e., mobile station to base station link) and a forward link 26 (i.e., base station to mobile station link) according to a CDMA or other communications protocol. The base station 14 determines if the reverse link 24 has reached a predetermined level of loading. For doing so, the base station 14 may first calculate a received signal strength indicator (“RSSI”) 30, and then determine if the RSSI 30 has risen above a designated threshold level. If the reverse link 24 has reached the predetermined level of loading, e.g., if the RSSI has risen above the designated threshold, then the base station 14 calculates a scaling factor 36. The base station 14 then scales its reverse link Eb/No setpoint 34 (or another control setting) by applying the scaling factor 36 to the Eb/No setpoint 34. Then, according to the new, scaled Eb/No setpoint 34, the base station 14 issues closed, inner loop power control commands to the mobile stations 18, thereby adjusting their transmit power as a function of the new, scaled Eb/No setpoint.

In carrying out radio communications, the mobile stations 18 transmit various traffic (i.e., data/voice) signals and control/system signals over the reverse link 24 to the base station 14. For example, a typical mobile station might have a maximum transmit power of no more than 500 mW, and more typically around 200 mW. The transmit power, reduced by a factor proportional to the distance between the mobile station and base station, is received at the base station's antenna(s) 16. The radio frequency power present at the base station antenna 16, as received from all the mobile stations 18 in the cell or sector 12 in the aggregate, can be expressed in terms of an RSSI. The RSSI also includes the power received from mobile stations that are controlled and/or located in other sectors and cells of the network, plus thermal noise, plus any other in-band interference. RSSI can be denoted in units of: 1) power in milliwatts (P_{mW}); 2) dBm (decibel milliwatts), where dBm=10 log (P_{mW}); or 3) an integer, e.g., from a scale that corresponds to an expected or typical range of power at the antenna. The key indicator of loading on the reverse link is not the absolute value of the RSSI, but the rise of the RSSI relative to a baseline unloaded value called the RSSI noise floor. The RSSI noise floor is measured when the system has close to zero reverse link loading, e.g., few or no active mobile stations. The RSSI rise, which is used in certain of the methods described herein, is calculated as the current measured RSSI minus the RSSI noise floor. As examples of various RSSI values, in a typical cellular network, an RSSI of between −98 dBm to −113 dBm (at the antenna) might be considered low, while an RSSI of above −98 dBm might be considered a high value. And again, as an example, an RSSI rise of <5 dB might be considered as low, while a rise of >5 dB might be considered as high, i.e., indicative of a substantially increased load on the reverse link.

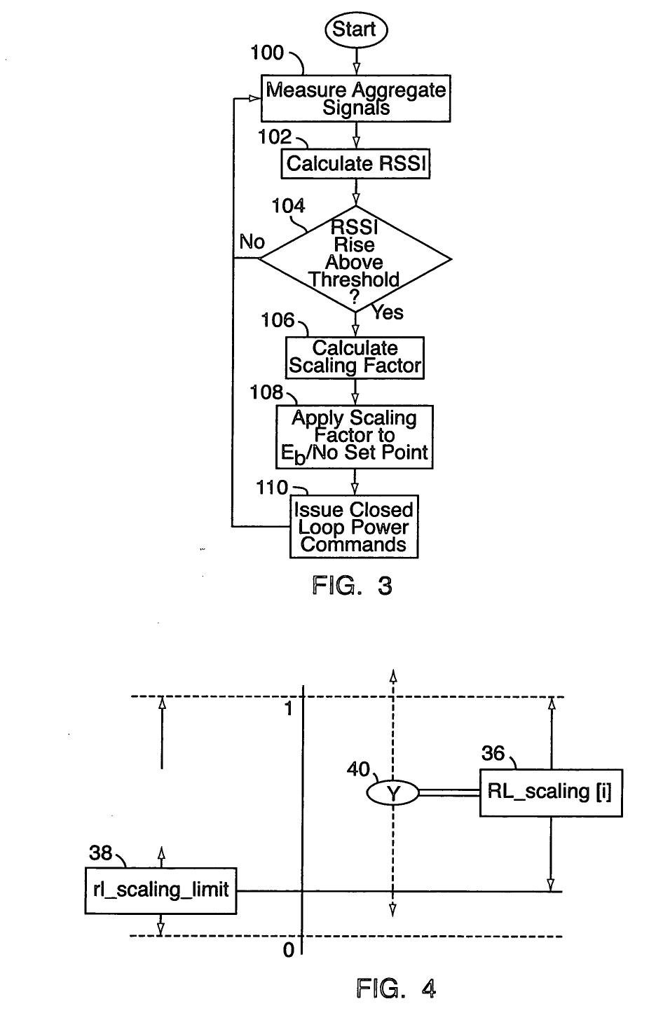

FIG. 3 illustrates one way in which the base station 14 might determine if the aggregate load on the reverse link 24 has reached a predetermined level. (By “predetermined,” it is meant a set, designated level, and/or a dynamic or varying level calculated according to an algorithm or the like.) As indicated at Step 100, the base station 14 measures the incoming signals as received at the antenna 16 (e.g., magnitude in volts or otherwise) using a standard electronic measuring module (not shown) in place on the base station 14 as part of the base station controller/electronics. From the measured aggregate received signal strength, a current RSSI value is calculated at Step 102, if needed, i.e., if the measured signal value is not directly suited/formatted for use as the RSSI. Then, at Step 104, the base station 14 determines if the cell or sector RSSI rise 30 has passed a designated, settable scaling threshold (denoted “scaling_threshold1”). As noted above, the RSSI rise 30 is the difference between the current RSSI and the RSSI noise floor, i.e., current RSSI-RSSI noise floor, and is denoted “RSSI_rise”. The scaling threshold is a value above which it is deemed worthwhile to scale the Eb/No setpoint 34, and below which it is deemed unnecessary to scale the Eb/No setpoint 34. Depending on the particular characteristics of the cellular network, the scaling threshold will typically be a configurable relative numerical value, as determined based on various service factors. For example, one value might be selected for voice traffic, and another for data, with provisions to set them differently on different carriers. The values might also be based on levels of desired capacity (which provides maximum limits), as well as the RF conditions to be supported at some target error rate/quality (which provides lower limits).

As an example, a scaling_threshold1=4 would map to an RSSI rise of 6 dB, which is to say a fourfold increase in the received power in mW from the baseline value (noise floor):
dB=10 log (P_{New}_{_{—}}_{mW}/P_{Old}_{_{—}}_{mW})
P_{New}_{_{—}}_{mW}=4P_{Old}_{_{—}}_{mW}
6 dB=10 log(4P_{Old}_{_{—}}_{mW}/P_{Old}_{_{—}}_{mW})

If it is found that the calculated RSSI_rise 30 has exceeded the scaling threshold at Step 104 (or if it is otherwise determined that the aggregate load on the reverse link has reached a predetermined level), the base station, at Step 106, calculates a scaling factor 36 (denoted as “RL_scaling[i]”) for controlling (e.g., scaling) the Eb/No setpoint 34. Thus, Steps 102-106 can be summarized as: when RSSI_rise reaches scaling_threshold1, the base station 14 calculates RL_scaling[i].

The scaling factor RL_scaling[i] 36 (see FIG. 4) is calculated according to the following:
RL_scaling[i]=max{rl_scaling_limit, min(1,Y)}
Y=RL_scaling[i−1]·[(1−1/scaling_window)+(1/scaling_window)·(RSSI_scaling_threshold/RSSI_rise)]
Thus, RL_scaling[i] is set to equal whichever is greater, “rl_scaling_limit” 38 or the lower of 1 or Y (“Y” is an arbitrary designation), where Y is calculated as set forth above. As should be appreciated, the following hold true from this equation:
min(1,Y)≦1
rl_scaling_limit<1
RL_scaling[i]=value between and including 0 and 1 (practically, RL_scaling[i] will not be zero, for reasons discussed below)

In the equation above, although RL_scaling[i] can vary between 0 and 1, rl_scaling_limit 38 represents a lower limit on the scaling factor RL_scaling[i] 36. This prevents the scaling factor from going to 0 or to a very low number as would greatly lower the Eb/No setpoint 34 and, in effect, prevent the reverse link from being active. Additionally, as indicated, “RL_scaling[i−1]” represents the scaling factor RL_scaling 36 in the previous epoch or time period, i.e., RL_scaling as previously calculated, or the “old” RL_scaling. The value “scaling_window” is a time constant (discussed further below), while “RSSI_scaling_threshold” is a reference threshold above which a control action is started. Typically, RSSI_scaling_threshold will be the same as scaling_threshold1.

RL_scaling[i] 36 is shown graphically in FIG. 4. There, rl_scaling_limit 38 is adjustable between 0 and 1. Typically, it will be a value not too close to either 1 or 0, to prevent the scaling factor 36 from approaching 0 while allowing for scaling to occur. (If rl_scaling_limit 38 was set at 1, RL_scaling[i] would always be 1, and no scaling would occur.) For example, some systems might impose a lower limit of 0.7-0.8 on RL_scaling[i]. Additionally, RL_scaling[i] 36 tracks the “Y” value 40 within a range of rl_scaling_limit 38 (minimum) to 1 (maximum).

Conceptually, the equation for calculating “Y” 40 represents an averaging function used for smoothing the effects of variations in the RSSI measurements. Thus, for calculating “Y”, an IIR (infinite impulse response) low-pass averaging filter may be used. Within that context, the value of “Y”, namely, RL_scaling[i] when “Y” is between rl_scaling_limit and 1, would be an average with its value tending towards a new “steady state” value from its current value, and taken over the time window scaling_window as the time constant for the averaging filter, e.g., possibly, though not necessarily, a 1-tap filter.

At Step 108 in FIG. 3, RL_scaling[i] is applied to the base station Eb/No setpoint 34, thereby scaling the Eb/No setpoint 34, according to the following:
Eb/No[i]=Eb/No[i−1]·(RL_scaling[i]/RL_scaling[i−1])
Thus, the “new” Eb/No setpoint equals the product of the “old” Eb/No setpoint (i.e., the Eb/No setpoint in the previous epoch) and the ratio of the current scaling factor and the previous scaling factor. From this equation, it can be seen that if RL_scaling stays the same between two epochs, the Eb/No setpoint is not scaled. Additionally, in factoring in the equation for “Y” 40, it can be seen, generally speaking, that when RSSI_rise passes above RSSI_scaling_threshold, the Eb/No setpoint is decreased, whereas when RSSI_rise falls below RSSI_scaling_threshold, the Eb/No setpoint is increased. This can be verified conceptually by combining the equation for “Y” 40 with the equation above for scaling the Eb/No setpoint, in the special case where “Y” is between rl_scaling_limit and 1, and neglecting the effect of scaling_window:
Eb/No[i]=Eb/No[i−1]·(RSSI_scaling_threshold/RSSI_rise)

In the cellular network, the base station Eb/No setpoint 34 determines, at least in part, the transmit power of the mobile stations 18. Thus, at Step 110 in FIG. 3, once the Eb/No setpoint 34 is scaled, the base station 14 issues closed, inner loop power control commands over the forward link 26, based on the scaled Eb/No setpoint 34. This is done every epoch, with the base station returning to measuring the received signals as at Step 100.

In soft-handoff, the various base stations 14 in the cellular network can operate with either the same Eb/No setpoint (i.e., global) or different Eb/No setpoints (i.e., local). As should be appreciated, the Eb/No setpoint 34, as controlled (e.g., scaled) according to the above, is a local setpoint, that is, the setpoint for the particular cell or sector 12 served by a particular base station 14. Typically, the global Eb/No setpoint will continue to be calculated according to whatever known algorithm(s) is being used in the cellular network, e.g., the “select CRC” or “min Eb/No” algorithms.

Typically, the Eb/No setpoint 34 will have a designated maximum value 42 and a designated minimum value 44 that together set the limits within which the Eb/No setpoint can vary. (These are also both control settings, where by “control setting” it is meant any of the settings associated with the control parameters of the reverse link, e.g., Eb/No, that determine how the base and mobile stations communicate, within the context of the communications protocol used.) According to an additional embodiment of the invention, the maximum value 42 allowed for the Eb/No setpoint (denoted as “Max_Eb/No_setpoint[i]”) may be scaled similarly to as above:
Max_{—}Eb/No_setpoint[i]=Max_{—}Eb/No_setpoint[i−1]·(RL_scaling[i]/RL_scaling[i−1])
This operation is optional, and the maximum value for the Eb/No setpoint may remain un-scaled.

Data transmissions from the mobile stations 18 to the base station 14 are typically divided into formatted frames, which are digital data packets each having a particular duration and/or length. The frame error rate (“FER”) refers to the rate of errors in the data frames as received at the base station 14. A reverse link target FER (denoted as “Target_RFER[i]”), which is another control setting, is usually set in the base station 14, and represents a maximum acceptable FER across the cellular network reverse link, i.e., it is desired to keep the actual reverse link FER below the reverse link target FER. According to an additional embodiment of the present invention, the reverse link target FER is optionally scaled according to the following, under these operating conditions (e.g., RSSI_rise>scaling_threshold1). Once the condition is removed, then this “inverse” scaling will be removed such that Target_RFER remains the same as the baseline value for the reverse link target FER, denoted “baseline_Target_RFER”:
Target_RFER[i]=baseline_Target_RFER (1+K/RL_scaling[i])
In this equation, “K” is a constant that regulates the effect of RL_scaling[i] on the reverse link target FER, and will be chosen based on the desired amount of scaling. Additionally, “baseline_Target_RFER” refers to a baseline value for the reverse link target FER, i.e., a baseline value that will be scaled/adjusted, which will be chosen based on the acceptable range of FER in the reverse link. From the equation, it can be seen that as RL_scaling[i] decreases, the scaling factor “(1+K/RL_scaling[i])” increases, increasing Target_RFER[i], while as RL_scaling[i] increases, the scaling factor decreases, decreasing Target_RFER[i]. This is the inverse of the effect of RL_scaling[i] on the Eb/No setpoint, wherein as RL_scaling[i] decreases, the Eb/No setpoint decreases. This is expected, since a decrease in the Eb/No setpoint (i.e., signal quality, or signal-to-noise ratio) means that a higher error rate is acceptable.

The control/scaling operations set forth above may be carried out only with respect to a selected set of mobile stations 18. For example, scaling may be more desirous for “high-impact” mobile stations, i.e., the mobile stations having higher set points or data rates. For carrying out the scaling with respect to a particular selected set of mobile stations, the closed loop power commands, etc. would only be issued by the base station to the selected set of mobile stations.

The equations given above for scaling the Eb/No setpoint are for positive values of the Eb/No setpoint only. Equations for absolute negative values of the setpoint, e.g., where the Eb/No setpoint is expressed as a negative dB value, may be slightly different. One approach would be to add a constant offset to push the range of the Eb/No setpoint in the positive region (>0).

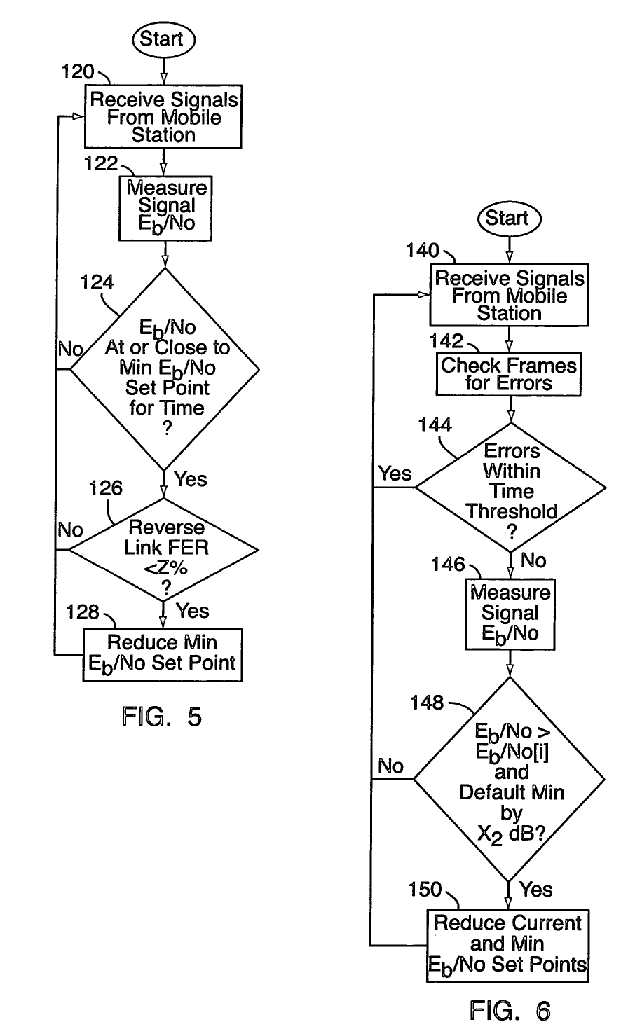

Optionally, after the base station 14 receives a sufficiently long string of good frames, the minimum value 44 for the Eb/No setpoint (denoted “Min_Eb/No_setpoint”) may be reduced. This reduction can be coordinated for all the sectors of a call in soft-handoff, or it can be done autonomously at each individual sector. With reference to FIG. 5, at Step 120, the base station 14 receives signals (e.g., data traffic) from a mobile station 18 over the reverse link 24. At Step 122, the base station measures or calculates a quality or characteristic of the received signals, e.g., the signal's Eb/No, or the bit error rate, which is related to Eb/No as a function of the communications protocol utilized. At Step 124, it is determined if the Eb/No of the mobile station signal has been within a window surrounding Min_Eb/No_setpoint, i.e., close to or at Min_Eb/No_setpoint, for a designated time interval (denoted “time_threshold1”). Initially, Min_Eb/No_setpoint will be set to an initial or default value. If the signal Eb/No has been at or close to the minimum Eb/No setpoint for the time threshold, at Step 126, the base station 14 determines whether or not the reverse link FER is less than a preset value Z %, where “Z” is a variable that represents an acceptable FER for communications over the reverse link, and typically a value less than the maximum allowed FER. If so, then at Step 128 Min_Eb/No_setpoint is reduced by “X₁” dB in 1 or 2 dB steps. Conceptually, this optional operation means that if the signal quality (Eb/No) is close to the minimum allowed level, and the error rate is below accepted limits, it is possible to reduce the minimum Eb/No setpoint without unacceptably lowering transmission quality, keeping in mind that even if the FER increases somewhat, it should still be within accepted limits if Z is chosen properly.

FIG. 6 shows an additional operation for reducing Min_Eb/No_setpoint. There, at Step 140, the base station 14 receives signals (divided into frames) from a mobile station 18. At Step 142, the base station 14 checks the frames for errors. At Step 144, if there are no errors within a second designated time interval (denoted “time_threshold2”), the base station 14 measures the signal's Eb/No (or other quality indicator) at Step 146. Then, at Step 148, the base station determines whether or not the measured signal Eb/No is greater than both the current Eb/No setpoint 34 and a value denoted as “Default_min_setpoint” by at least “X₂” dB. Default_min_setpoint may be the same as the default value for Min_Eb/No_setpoint, i.e., the value set for Min_Eb/No_setpoint as a default or initial value, before any scaling/reduction of Min_Eb/No_setpoint occurs. If so, at Step 150, Min_Eb/No_setpoint and the current Eb/No setpoint 34 are both reduced by X₂ dB. Since there is a chance that suddenly lowering the Eb/No setpoint by a significant amount would unacceptably reduce transmission quality, the value for X₂ is chosen so as to likely not cause a sudden increase in the FER.

To maintain transmission quality, the base station 14 may optionally increase Min_Eb/No_setpoint based on errors detected in the signal transmitted from one or more of the mobile stations 18 to the base station 14. For example, if an error is detected within “time_threshold3” from when Min_Eb/No_setpoint is reduced as set forth above, or if there is a string of errors within “time_threshold4” from when Min_Eb/No_setpoint is reduced, then the base station 14 may increase Min_Eb/No_setpoint by X₃ dB. Additionally, the increase in Min_Eb/No_setpoint may be made in a multi-level manner, e.g., an increase by X₄ dB if within time_threshold4, or an increase by X₅ dB if within a “time_threshold5”. The variables time_threshold3-time_threshold5 are time intervals that are chosen based on the particular characteristics of the cellular network, e.g., data bandwidth, acceptable FER, or the like. Similarly, the variables X₃-X₅ are chosen to incrementally increase Min_Eb/No_setpoint to alleviate errors. Thus, for example, if the occurrence of a string of errors within a particular time interval would result in unacceptable signal quality, then time_threshold4 would be chosen to correspond to that time interval, and X₄ would be chosen so that if Min_Eb/No_setpoint was raised by X₄ dB, the rate of errors would be reduced to an acceptable limit. X₄ might also be an incremental increase, to avoid unnecessarily over-increasing Min_Eb/No_setpoint.

Conditions across the reverse link 24 may be evaluated in terms of more than one characteristic, i.e., more than a 1-dimensional evaluation of RSSI by itself. For example, a 2-dimensional evaluation may involve two characteristics such as RSSI and internal loading, and a 3-dimensional evaluation may involve three characteristics such as RSSI, internal loading, and the current reverse link FER. In such a case the reverse link scaling threshold may be similarly multi-dimensional, i.e., a scaling threshold for each characteristic.

As should be appreciated, the present invention is applicable to all transmissions across the reverse link, be they voice, data, or voice/data transmissions. Control (e.g., scaling) actions can be based on, at least in part, mobile station transmission rates, as well as on quality of service or guarantee of service specifications as set forth in service plans.

Since certain changes may be made in the above-described method for extracting the optimal reverse link capacity by scaling the reverse link Eb/No setpoint based on aggregate channel load and condition, without departing from the spirit and scope of the invention herein involved, it is intended that all of the subject matter of the above description or shown in the accompanying drawings shall be interpreted merely as examples illustrating the inventive concept herein and shall not be construed as limiting the invention.

We claim:

1. A method for controlling a cellular network reverse link, said method comprising the steps of:
determining whether the reverse link has reached a predetermined level of loading, and, if so:
calculating a scaling factor for a control setting associated with one or more control parameters of the reverse link; and
applying the scaling factor to the control setting.

2. The method of claim 1 wherein:
the control setting is an Eb/No setpoint; and
the step of determining whether the reverse link has reached the predetermined level of loading comprises the sub-steps of:
calculating a rise in a received signal strength indicator; and
determining whether the rise has passed a threshold indicative of a substantially increased load on the reverse link.

3. The method of claim 1 wherein:
the step of determining whether the reverse link has reached the predetermined level of loading comprises the sub-steps of:
measuring a level of reverse link loading; and
comparing the measured level with the predetermined level; and
the scaling factor incorporates one or both of the measured level and the predetermined level.

4. The method of claim 3 wherein:
the scaling factor is calculated, at least in part, as the product of a previous scaling factor and the quotient of the predetermined level and the measured level of reverse link loading; and
the scaling factor has a maximum value of 1 and a minimum value of a scaling limit, said scaling limit being greater than 0.

5. The method of claim 4 wherein:
the step of applying the scaling factor comprises applying a quotient of the new, calculated scaling factor and the previous scaling factor.

6. The method of claim 1 further comprising the step of:
issuing power commands to at least one mobile station based on the control setting as scaled.

7. The method of claim 1 wherein the scaling factor incorporates a previous scaling factor calculated in a previous epoch or time period.

8. The method of claim 1 wherein the control setting is selected from the group consisting of: an Eb/No setpoint; a maximum value for the Eb/No setpoint; and a target reverse link frame error rate.

9. The method of claim 1 further comprising the steps of:
measuring at least one quality of at least one signal received across the reverse link; and
determining if the at least one quality is within a window surrounding a second control setting for a time interval, and, if so, adjusting the second control setting by a predetermined amount.

10. The method of claim 9 wherein:
the at least one quality is an error rate; and
the second control setting is a minimum value of an Eb/No setpoint.

11. The method of claim 9 wherein:
the at least one quality is an error rate;
the second control setting is a minimum value of an Eb/No setpoint; and
the method further comprises the step of adjusting the minimum value of the Eb/No setpoint upwards if the error rate is greater than a predetermined value.

12. The method of claim 1 wherein the steps of calculating and applying the scaling factor comprise:
calculating one or more scaling factors for one or more control settings associated with one or more control parameters of the reverse link; and
applying the one or more scaling factors to the control settings.

13. A method for optimizing reverse link capacity comprising the steps of:
determining whether a rise in the aggregate load of the reverse link has reached a predetermined level of loading, and, if so:
adjusting a control setting associated with one or more control parameters of the reverse link; and
issuing commands to adjust transmissions across the reverse link based at least in part on the adjusted control setting.

14. The method of claim 13 wherein:
the step of adjusting the control setting comprises the sub-steps of calculating a scaling factor and applying the scaling factor to the control setting.

15. The method of claim 14 wherein the control setting is selected from the group consisting of: an Eb/No setpoint; a maximum value for the Eb/No setpoint; and a target reverse link frame error rate.

16. The method of claim 14 wherein the step of determining whether the rise in the aggregate load of the reverse link has reached the predetermined level comprises the sub-steps of:
calculating a received signal strength indicator (RSSI);
calculating a rise in the RSSI; and
determining whether the rise in the RSSI has passed a threshold indicative of a substantially increased load on the reverse link.

17. The method of claim 16 wherein the scaling factor incorporates the rise in the RSSI.

18. The method of claim 17 wherein:
the scaling factor is calculated, at least in part, as the product of a previous scaling factor and the quotient of a scaling threshold and the rise in the RSSI; and
the scaling factor has a maximum value of 1 and a minimum value of a scaling limit, said scaling limit being greater than 0.

19. The method of claim 18 wherein:
the step of applying the scaling factor comprises applying a quotient of the calculated scaling factor and the previous scaling factor.

20. A method for optimizing reverse link capacity comprising the steps of:
calculating a received signal strength indicator (RSSI);
determining whether a rise in the RSSI has passed a threshold, and, if so:
calculating a scaling factor incorporating a value of the rise in the RSSI;
lowering an Eb/No setpoint of the reverse link based on the scaling factor; and
issuing commands to one or more mobile stations to adjust transmissions across the reverse link, based at least in part on the lowered Eb/No setpoint.
